(19) United States
(12) Patent Application Publication
(10) Pub. No.: US 2007/0170716 A1
(43) Pub. Date: Jul. 26, 2007

(54) RETURN LABEL AND TRACKING SYSTEM

(76) Inventors: James J. Cerkleski, South Barrington, IL (US); Eric F. Martin, South Barrington, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/531,766

(22) Filed: Sep. 14, 2006

Related U.S. Application Data
(60) Provisional application No. 60/596,303, filed on Sep. 14, 2005.

(51) Int. Cl. B42D 15/00

(52) U.S. Cl. 283/101

(57) ABSTRACT

A return label and tracking system is disclosed. The label of the present invention is a multi-layer label having a backing, a middle layer shipping label, and a top layer. The backing is pealed away to expose a permanent adhesive to affix the label to a box. The top layer is removably adhered to the shipping label. When a customer is ready to ship back an item, such as a depleted toner cartridge, for recycling or repair, the top layer can be removed to expose the shipping label, and the box can be shipped via a courier service or mail service. The shipping label is a variable label. The tracking system enables the receiver to determine which customer sent the item by having a record of which shipping labels were assigned to which customers. Thus, the customer can be credited for items returned.

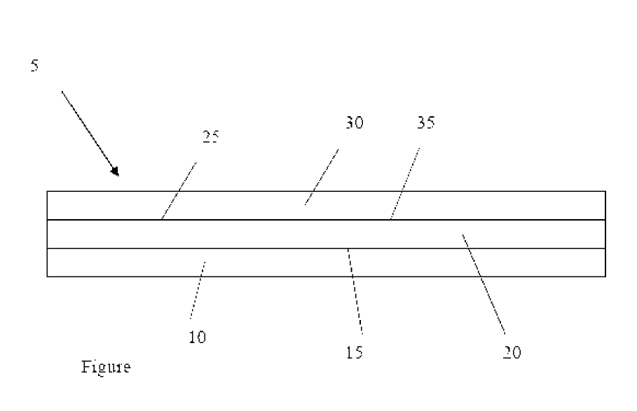

### CROSS-REFERENCE TO RELATED APPLICATION

This application claims the benefit of U.S. Provisional Application No. 60/596,303, filed on Sep. 14, 2005, which is hereby incorporated by reference in its entirety.

### FIELD OF THE INVENTION

The present invention relates to return labels and tracking systems. More specifically, the present invention relates to a multi-layer label having tracking information thereon and a tracking system associated therewith.

### DESCRIPTION OF THE RELATED ART

In various industries, products which are sold, or portions of them, are to be returned by the consumer for repair or recycling. For example, in the toner and ink cartridge industries, depleted cartridges are often repaired or recycled by remanufacturers.

One way in which items are returned are by postal service or courier via a return label which is placed on the box by the consumer. Labels may be supplied to the consumer by the manufacturer or distributor of the product. However, in some situations, the consumer may also have the option to return the product on a delivery truck. Labels to indicate that the item should be returned to a distribution center may also be provided.

Previous attempts to provide such labels have been inconvenient, and are lacking in that the ability to track which consumers or which distribution centers the product has passed through is lacking. Such tracking can be important if the customer is to be credited or paid for the return of the product.

Thus, there remains a need for a convenient manner in which to provide labels to consumers, and a system for tracking which customer a returned product has been delivered by.

### SUMMARY OF THE INVENTION

In view of the insufficiencies discussed above, it is an object of the present invention to provide a convenient labeling a tracking system for returned products.

The present invention includes a tracking system and multi-layer label for returned items. A label is provided having a backing, a middle layer comprising a shipping label, and a top layer comprising instructions. The label is placed on a box after removing the backing. The top layer covers the shipping label to prevent the box from being accidentally shipped via the shipping label.

Once the customer is ready to return the item, such as when a toner cartridge has been depleted, the customer has the option to remove the top layer to expose the shipping label and ship the item via a mail or courier service. The receiver can track from whom the item came by having a record of which shipping labels, identified by an identifier such as a UPS ARS number, were assigned to which customers. The label can then be scanned and customers can then be credited accordingly.

Other features and advantages of the invention will be apparent from the following detailed description take in conjunction with the following drawing.

### BRIEF DESCRIPTION OF THE DRAWING

The FIG. shows a cross sectional view of one embodiment of the present invention.

### DETAILED DESCRIPTION OF THE INVENTION

While this invention is susceptible of embodiments in many different forms, there are shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

The present invention is label and tracking system. The label 5 is preferably a multi-layer label. A removable backing 10 can be removed to expose a second layer 20 having an adhesive 15 which permanently adheres to a package. This second layer 20 has a top surface 25 comprising a shipping label 25. The shipping label 25 can be suitable for use by any mail or courier service. In various preferred embodiments, the shipping label 25 includes a tracking number or identifier used by a courier service. For example, it may include a UPS ARS number.

The second layer 20 is covered by a top layer 30 which is a “pull away” label having a non-permanent adhesive 35 adhering it to the second layer 20. The top layer 30 may have instructions to the consumer to indicate how to return the product. The top layer 30 can also be used for a variety of other optional purposes. For example, the top layer label 30 can provide advertising or promotion space, provide motivation for the consumer to recycle such as by indicating that a charitable contribution is made for each product recycled, or provide alternate routes of return such as by instructing the consumer to provide the product to the delivery truck driver of the product upon return. Various options may be provided to the consumer. For convenience, the backing may be die cut, and the die cut would extend through the second layer in order to facilitate the removal of the top pull-away label.

In practice, the label 5 can be adhered to the box for the product by a distribution center. The label 5 is printed using a specifically designed printing process to print a variable second layer label 20 and a top label 30. The backing 10 is removed by the distribution center and placed on the package. The top layer 30 covers the shipping label 25, and thus prevents the box from being shipped as per the shipping label by mistake. When the consumer receives the box, the top label instructs the consumer how to return the item. For example, if the item is a depleted toner cartridge, once the cartridge is depleted, the consumer may have a choice to either return the cartridge in the box to the delivery truck without removing the label 5, return it to a recycling repository, or remove the top label 30 and ship it, preferably prepaid by another party, via any specified mail or courier service.

The tracking system of the invention functions as follows. When the shipping label portions of the labels are printed, the manufacturer/remanufacturer tracks which labels are shipped to which customers/distribution centers. A separate variable indication can be placed on the shipping label to identify the label. However, in an ideal embodiment, the shipping identification on the label, such as a UPS ARS number is utilized. This number is typically advantageously encoded in a manner in which it can be scanned, such as a bar code. Thus, the remanufacturer can enter into a software program which identifiers or which ARS numbers are to be shipped to a particular customer/distribution center.

Upon receiving the returned items, the remanufacturer is able to determine, such as by scanning, which items have been returned from which customers. Thus, if a customer/retailer is being paid for returned items, the remanufacturer can track the items returned and compute the amounts due to each customer.

The tracking system of the present invention is particularly useful in the toner cartridge industry. Depleted toner cartridges are frequently either recycled or repaired by a toner cartridge remanufacturer. Remanufacturing companies will typically pay a retailer or customer for returned empty cartridges. Thus, they need to be able to track from what source the empty cartridge comes. The present invention provides an efficient manner for this to be facilitated.

While the specific embodiments have been illustrated and described, numerous modifications are possible without significantly departing from the spirit of the invention, and the scope of protection is only limited by the scope of the accompanying claims.

What is claimed is:

1. A return label comprising:
a top layer having indicia on an upper surface thereof, and a non-permanent adhesive on a lower surface thereof,
a middle layer comprising shipping information on an upper surface thereof, and a permanent adhesive on a lower side thereof, and
a removable backing.

2. The return label according to claim 1, wherein said shipping information comprises an identifier.

3. The return label according to claim 1, further comprising a die cut through a portion of said middle layer to facilitate removal of said top layer.

4. The return label according to claim 2, wherein said identifier is an identifier used by a mail or courier service.

5. The return label according to claim 4, wherein said the indicia on said top layer comprises return instructions.

6. A method of tracking items to be return shipped by a consumer comprising the steps of:
providing a label having a variable shipping label portion covered by a top label removably adhered thereto,
recording an identifier on said shipping label as corresponding to a particular customer,
enabling a consumer to remove said top label to expose said shipping label, identifying said identifier on said shipping label upon receipt of said item, and
crediting the customer associated with said identifier for the receipt of the item.
